(19) United States
(12) Patent Application Publication
(10) Pub. No.: US 2016/0353668 A1
(43) Pub. Date: Dec. 8, 2016

(54) COMMERCIAL LEAF VACUUM AND MULCHER APPARATUS

(71) Applicant: Lucas W. Mayer, Belleville, IL (US)

(72) Inventor: Lucas W. Mayer, Belleville, IL (US)

(21) Appl. No.: 15/173,292

(22) Filed: Jun. 3, 2016

Related U.S. Application Data
(60) Provisional application No. 62/170,220, filed on Jun. 3, 2015.

(51) Int. Cl. A01G 1/12

(52) U.S. Cl. CPC A01G 1/125

(57) ABSTRACT

An outdoor power device for the removal and mulching of large amounts of leaves and debris comprising a mulching chamber, mulching apparatus within the mulching chamber, an impeller fan within the mulching chamber; a motor operatively associated with the impeller fan; an adjustable, downwardly disposed pick-up chute associated with the impeller fan, said chute having a proximal end attached to the mulching chamber and an intake at a distal end of the tube; and a discharge tube at the top of the mulching chamber. The outdoor power device can be provided as a kit to convert a straw blower to a vacuum apparatus.

### CROSS-REFERENCE TO RELATED APPLICATIONS

This Non-Provisional application claims priority to U.S. Provisional Application Ser. No. 62/170,220 filed Jun. 3, 2015, and which is incorporated herein by reference.

### STATEMENT REGARDING FEDERALLY SPONSORED RESEARCH

Not applicable.

### BACKGROUND

The present invention relates to outdoor lawn maintenance equipment. More particularly, the present invention relates to leaf blowers, vacuums and mulching equipment.

Typically, leaf blowers are relatively small and portable having motor or engine driven fans disposed to discharge air through a discharge tube at a high velocity. Most leaf blowers are handheld or shoulder-carried and used by homeowners for landscaping and grooming purposes.

Generally, there are several types of lawn vacuums and leaf vacuums. For instance, one type is an adaptation of the conventional, small, handheld leaf blower described above wherein the discharge tube is repositioned to redirect the airflow such that the leaf blower creates a vacuum for sucking leaves and debris into a collection bag. Another common type of vacuum is an adaptation of a lawn mower or garden tractor that sucks up grass and leaves and deposits them into a collection container.

Most mulching apparatus comprise specialized mower blades and closed mower decks that confine leaves and grass, subjecting them to repeated chopping resulting in mulched yard refuse.

These different devices are generally available as separate pieces of equipment. Moreover, most conventional devices are small, portable or intended for small jobs by homeowners or noncommercial use. Therefore, it is desirable to have a unitary apparatus capable of performing multiple tasks including, vacuuming, mulching and removing large amounts of leaves and debris. Such a device could be use along roadways, in parks, golf courses or other areas where large amounts of unwanted leaves and debris may accumulate.

### SUMMARY

An outdoor power device for removal and mulching of large amounts of leaves and debris having a mulching chamber, a mulching device inside the mulching chamber, an impeller fan associated with the mulching chamber, a motor to drive the impeller fan, a downwardly disposed pick-up chute associated with the impeller fan, and a discharge tube at the top of the mulching chamber. The outdoor power device can be mounted on a trailer to comprise a wheeled carriage for mobility. The outdoor power device can also be provided as a kit to convert a straw blower to a vacuum/mulching apparatus.

### DESCRIPTION OF THE DRAWINGS

In the accompanying drawings which form part of the specification:

FIG. 1 is a perspective view of on aspect of an outdoor power device of the present invention;

FIG. 2 is an end plan view of the outdoor power device of the present invention;

FIG. 3 is a perspective view of a vacuum tube bolted to an impeller housing of the outdoor power device of the present invention;

FIG. 4 is a perspective view of the vacuum tube of the outdoor power device of the present invention; and

FIG. 5 is a front view of an intake chute of the vacuum tube of the outdoor power device of the present invention.

Corresponding reference numerals indicate corresponding parts throughout the several figures of the drawings.

### DETAILED DESCRIPTION

The following detailed description illustrates the claimed invention by way of example and not by way of limitation. The description clearly enables one skilled in the art to make and use the disclosure, describes several embodiments, adaptations, variations, alternatives, and uses of the disclosure, including what is presently believed to be the best mode of carrying out the claimed invention. Additionally, it is to be understood that the disclosure is not limited in its application to the details of construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting.

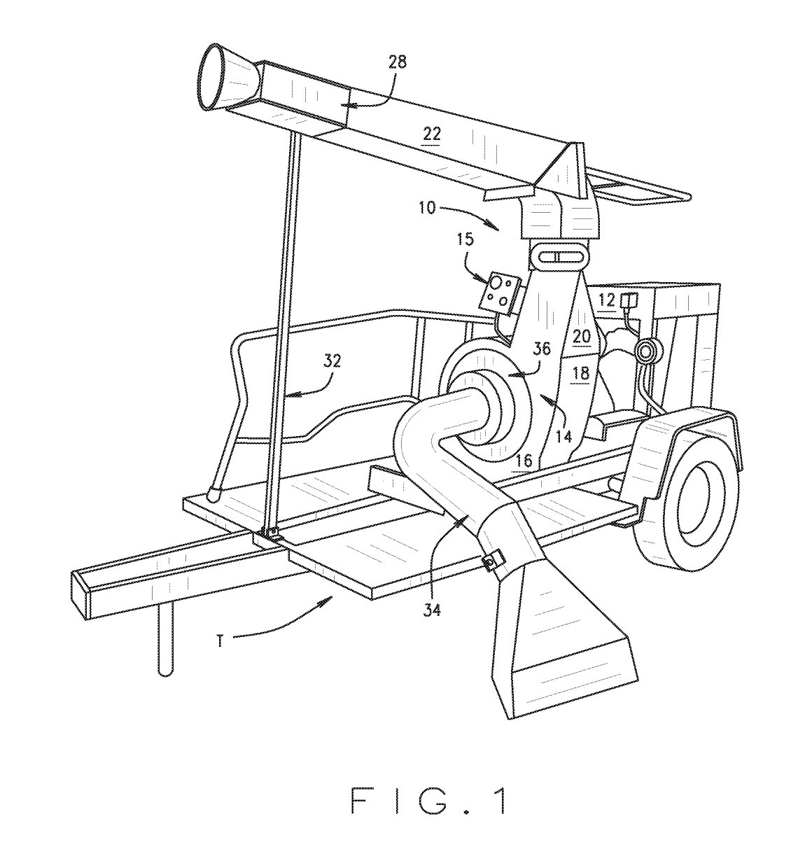

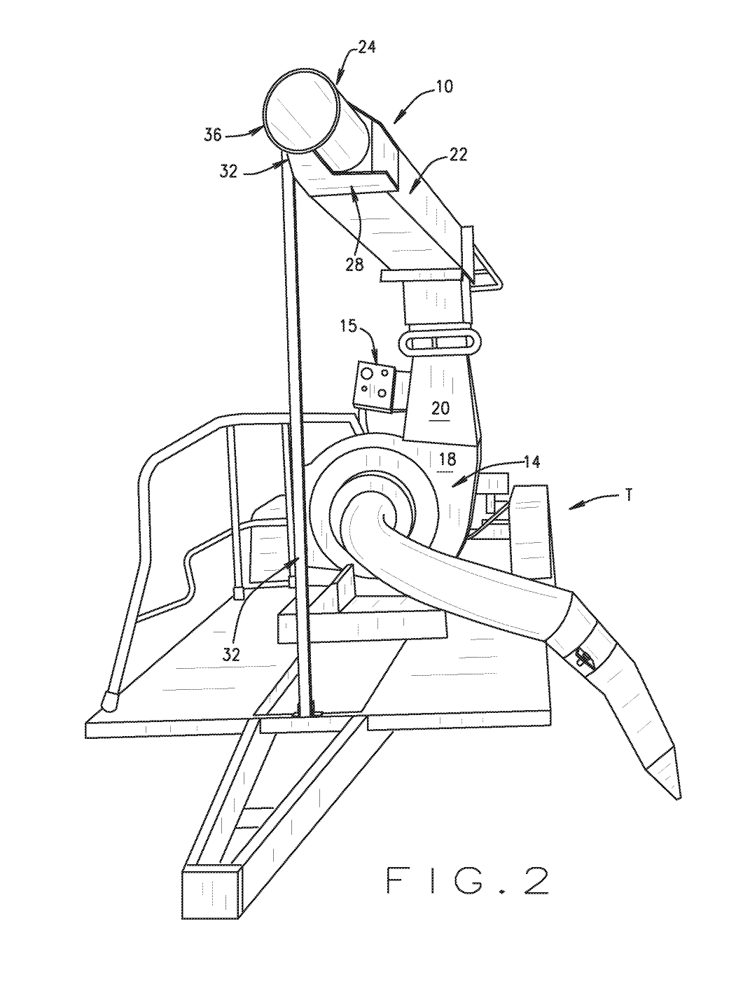

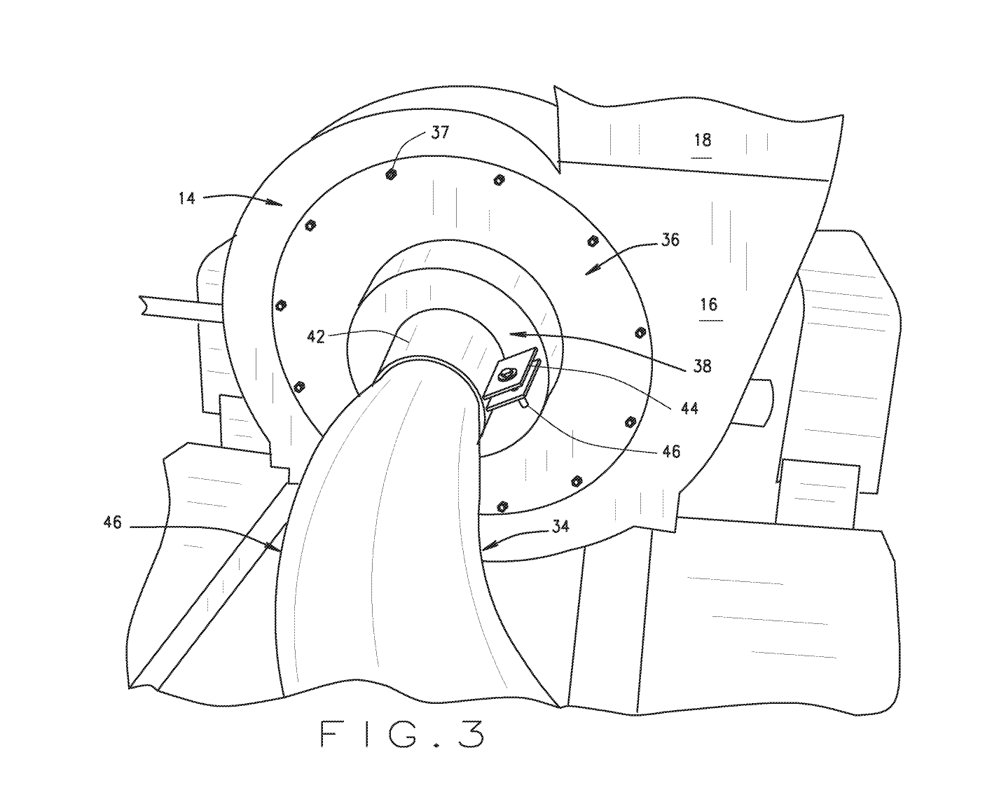

As shown in FIGS. 1-5, an embodiment constructed in accordance with the present disclosure, generally referred to as an outdoor power device 10, includes a motor or engine 12, an impeller housing 14 having an internal impeller fan (not shown) rotatably connected to engine 12 by a shaft (not shown). As illustrated in FIGS. 1-5, outdoor power device 10 is shown mounted on a trailer T to impart mobility to the apparatus. However, alternative embodiments could use any apparatus to allow mobility of the outdoor power device 10. In the embodiment of FIGS. 1-5, the device 10 is constructed by adapting a conventional straw blower. Unneeded elements of the straw blower are removed and the components of device 10 are attached. The conversion requires no drilled holes or welding. The conversion can be completed in approximately thirty minutes. The various elements can be provided as a kit.

Preferably, the engine is a gasoline engine having about 20 horsepower or diesel engine having about 50-60 horsepower along with respective controls 15 for operation. However, those skilled in the art will recognize that any type and size of engine could be used.

The impeller housing 14 is a generally cylindrical body 16 that defines an internal mulching or chopping chamber, a discharge section 18 and a substantially conically or pyramidal duct section 20. A discharge chute 22 located at the top of duct 20 is in fluid communication with the impeller housing 14.

Discharge chute 22 has a substantially rectangular cross-section, although any suitable shape could also be used. The end of the discharge chute 22 defines an outlet 24. As shown, outlet 24 is preferably an 8″ pipe 26 on flare 28 attached to the outlet 24 by a suitable means, such as clamping, welding, or fastening. A stand pole 32 extends between the trailer T to the outlet 24 attaching with brackets 30 to support the outlet 24 and discharge chute 22. This allows discharge chute 22 to remain pointed toward the tow vehicle (e.g. see the location of the trailer hitch H) even in transport. Preferably, the outlet 24 is adaptable to 8″ schedule 40 plastic pipe to allow for different lengths of pipe, depending on the tow/loading vehicle. If desired, material discharge can be piped to refuse containers or bags or rigid containers can be associated with the outlet.

The outdoor power device 10 includes a vacuum tube assembly 34 which comprises a generally circular flange 36 at the proximal end attached to an opening (not shown) of the impeller housing 14, such as with fasteners. To convert a conventional straw blower into the outdoor power device 10, the straw bale chute and loader table for loading bales into the straw chopping chamber are removed exposing the opening into the impeller housing 14. Fasteners 37, such as bolts, are used to attach the flange 36 at existing bolt holes. Flange 36 is a generally circular steel plate having a step down adapter 38 that accommodates a circular vacuum tube 40, preferably an eight (8) inch steel tube, however, any suitable size can be used. Vacuum tube 40 is secured to adapter 38 by a circular clamp 42 having opposed flanges 44 and a bolt 46. This arrangement allows the clamp to be loosened for desired orientation of vacuum tube 40 and then tightened to secure the tube in place. For example, vacuum tube 40 can be rotated around and positioned on the side of the device 10 opposite of that depicted in the FIGS. 1-5. Those skilled in the art will recognize that in conventional straw blowers the opening to the impeller (not shown) is typically about sixteen (16) inches in diameter. The adaptor 38 reduces the opening from about sixteen (16) inches to about eight (8) inches to increase suction and pull material into the device 10.

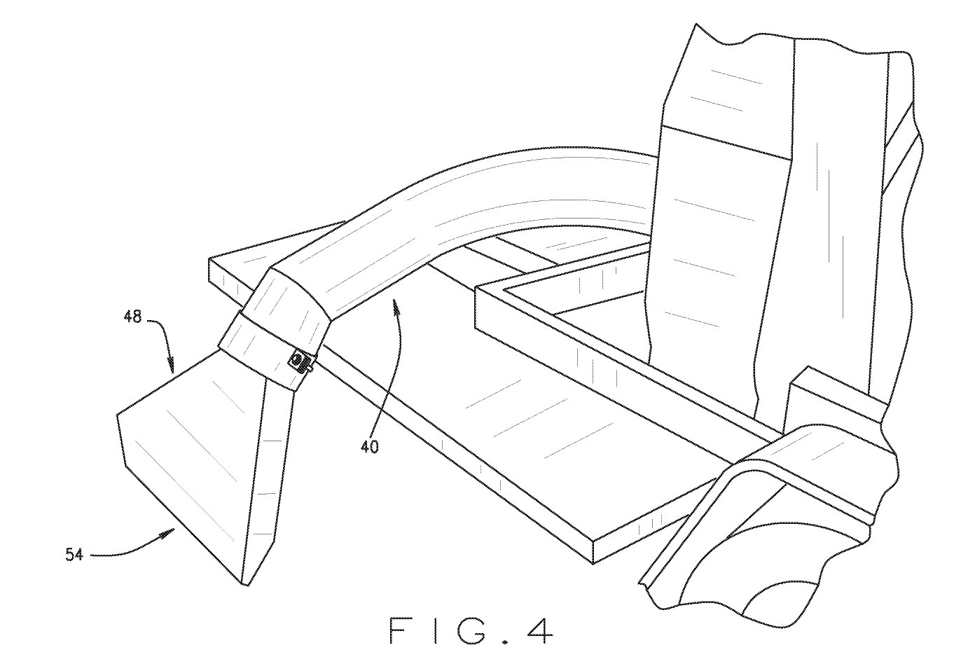

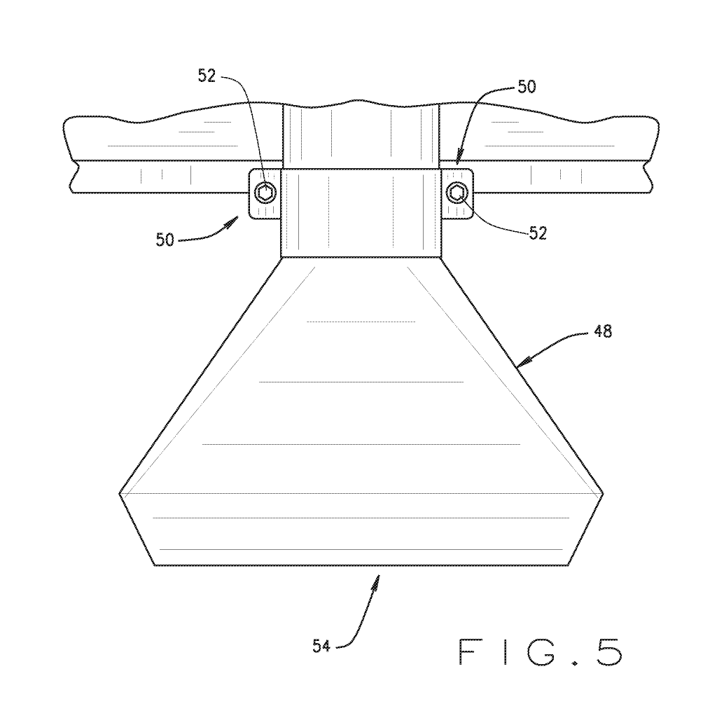

Vacuum tube 40 has a generally curved configuration that orientates the tube away from the impeller housing 14, over trailer T and downwardly towards the ground. The tube 40 includes a vacuum intake head 48 at the distal end of tube 40. As best seen in FIGS. 4 and 5, intake head 48 fits over the distal end of tube 40 and is secured by fasteners, such as flanges 50 and bolts 52, which can be loosened or tightened for adjustment. Bolts 52 allow for quick maneuverability, for example, rotationally. Also, the intake head can be extended or retracted on tube 40 depending upon how close the operator needs to get to a surface.

Intake head 48 defines a flared opening 54. The flared design of intake head 48 expands the area of opening 54 and provides a scoop-like effect. The configuration of tube 40 and intake head 48 allows the operator to position lower to the ground and the head adjacent a street curb or other surface, for example, for leaf and debris removal.

The impeller housing 14 contain chopping chains (not shown) for chopping the leaves and other debris, or other suitable devices. In general the chopping chains, also known as flail chains, are attached to the shaft that extends from the motor to the impeller and function by flailing or beating the leaves and other debris in to smaller pieces as the shaft rotates. The debris is chopped up small to consolidate the materials being loaded into a vehicle. It also destroys gumballs and finely shreds the material for compost or mulching applications. The chopped debris is expelled through discharge chute 22 as mulch or collected for disposal.

Changes can be made in the above constructions without departing from the scope of the disclosure, it is intended that all matter contained in the above description or shown in the accompanying drawings shall be interpreted as illustrative and not in a limiting sense.

What is claimed is:

1. An outdoor power device for the removal and mulching of debris, comprising:
a housing;
a discharge tube at the top of the housing;
a mulching apparatus mounted within the housing;
a motor mounted with the housing;
an impeller fan operatively connected to the motor; and
a pick-up chute operatively connected with the housing and impeller fan, the chute having an intake for receiving debris.

2. The outdoor power device of claim 1, further comprising a pole stand connected to the discharge tube for support.

3. The outdoor power device of claim 1, wherein the mulching apparatus comprises flail chains operatively connected to the motor.

4. The outdoor power device of claim 1, wherein the pick-up chute is positioned to intake debris from the ground.

5. The outdoor power device of claim 1, provided as a kit to convert a straw blower to the vacuum apparatus.

6. A kit for conversion of a straw blower into an outdoor power device for the removal and mulching of debris, the straw blower having a housing, a motor mounted within the housing, comprising:
a discharge tube at the top of the housing;
a mulching apparatus mounted within the housing;
an impeller fan operatively connected to the motor; and
a pick-up chute operatively connected with the housing and impeller fan, the chute having an intake for receiving debris.

7. The outdoor power device of claim 6, further comprising a pole stand connected to the discharge tube for support.

8. The outdoor power device of claim 6, wherein the mulching apparatus comprises flail chains operatively connected to the motor.

9. The outdoor power device of claim 6, wherein the pick-up chute is positioned to intake debris from the ground.

10. The outdoor power device of claim 6, provided as a kit to convert a straw blower to the vacuum apparatus.

11. A method for removal and mulching of debris with an outdoor power device, comprising the steps of:
providing a housing;
providing a discharge tube at the top of the housing;
providing a mulching apparatus mounted within the housing;
providing a motor mounted with the housing;
providing an impeller fan operatively connected to the motor; and
providing a pick-up chute operatively connected with the housing and impeller fan, the chute having an intake for receiving debris;
creating a vacuum in the pick-up chute with the motor and impeller;
vacuuming up debris with the pick-up chute;
mulching the debris with the mulching apparatus;
discharging the mulched debris with the discharge tube.
